(19) United States
(12) Patent Application Publication
(10) Pub. No.: US 2002/0171643 A1
(43) Pub. Date: Nov. 21, 2002

(54) Surface generator unit for and method of approximating an implicit surface and image display apparatus comprising the surface generator unit

(76) Inventors: Fabian Edgar Ernst, Eindhoven (NL); Cornelius Antonius Marie Van Overveld, Eindhoven (NL); Piotr Wilinski, Eindhoven (NL)

Correspondence Address: Corporate Patent Counsel, U.S. Philips Corporation, 580 White Plains Road, Tarrytown, NY, 10591, US

(21) Appl. No.: 10/131,968

(22) Filed: Apr. 25, 2002

(30) Foreign Application Priority Data
Apr. 26, 2001 (EP) 01201528.5

(51) Int. Cl. G06T 15/00

(52) U.S. Cl. 345/419

(57) ABSTRACT

If an implicit surface (120) is defined by means of values assigned to vertices of a cell-based structure then this implicit surface (120) can be approximated by means of a triangulated surface which can be visualized. The method of approximating an implicit surface (120) by generation of a triangulated surface comprising a plurality of triangles (128) is characterized in that a location of a particular triangle vertex (122) is inside a cell (100) of the cell-based structure. The location of the particular triangle vertex (122) is calculated by means of the values assigned to the cell vertices (102-116) of one or more cells (100,101).

The invention relates to a method of approximating an implicit surface by generation of a triangulated surface comprising a plurality of triangles each having triangle vertices, whereby a particular triangle vertex is based on values assigned to cell vertices of a cell corresponding with the particular triangle vertex.

The invention further relates to a surface generator unit for approximating an implicit surface by generation of a triangulated surface comprising a plurality of triangles each having triangle vertices, based on values assigned to cell vertices of a cell.

The invention further relates to an image display apparatus comprising:

a reconstructor designed to generate a cell-based structure to hold an implicit surface;

a surface generator unit for approximating the implicit surface by generation of a triangulated surface comprising a plurality of triangles each having triangle vertices, based on values assigned to cell vertices of a cell; and

a display device to display the triangulated surface.

A method of the kind described in the opening paragraph is known from the article “Marching Cubes; A High Resolution 3D Surface Construction Algorithm”, in Computer Graphics, Volume 21, Number 4, July 1987, pages 163-169. This article discloses the marching cube method. The marching cubes method is used for triangulation of an implicitly defined surface, which is a well-known problem in visualization. The setting for triangulation is as follows: From a series of measurements, values of a predetermined property u are obtained and assigned to cell vertices of a cell-based structure. The objective is to generate a triangulated surface which approximates the implicit surface f(u)=0. In the remainder of the text, f(u)=u is used, without loss of generality. A key requirement is that the triangulated surface should be consistent with the measurement values, and should therefore never cross a cell edge of which both end points have u>0 or both end points have u<0, i.e. both end points are on the same side of the implicit surface.

The marching cubes method uses a divide and conquer approach to locate the implicit surface in a logical cube, i.e. cell. The method determines how the implicit surface intersects this cube, then moves or marches to the next cube, i.e. cell. Use is made of the values assigned to the cell vertices to find the implicit surface intersection. In the marching cubes method each cell of a regular grid is triangulated separately. First, on each cell edge crossing the implicit surface a point is taken as a triangle vertex. The possibly non-planar polygon arising from these vertices is then triangulated by connecting the triangle vertices. From a look-up table the resulting triangulation can be computed. After processing all cells a triangulated surface has been created.

The marching cubes method has some disadvantages:

The marching cubes method tends to produce too many triangles, because the non-planar polygons that result from intersecting the implicit surface with each cell need to be triangulated.

If the cells differ in size, a large effort has to be spent on ensuring that the triangulated surface is C⁰-continuous from one cell to the other: The location of a triangle vertex calculated for an edge of a particular cell can differ relatively much from the location of a triangle vertex on the same edge but of a neighboring cell with different size. This is called the “crack” problem. For efficiency reasons, the cells of the structure on which the measurements are obtained vary often in size, for instance when the cells are structured as an octree.

It is a first object of the invention to provide a method of the kind described in the opening paragraph that solves the problem of the C⁰-discontinuity.

It is a second object of the invention to provide a surface generator unit of the kind described in the opening paragraph in which the problem of the C⁰-discontinuity does not occur.

It is a third object of the invention to provide an image display apparatus of the kind described in the opening paragraph comprising a surface generator unit in which the problem of the C⁰-discontinuity does not occur.

The first object of the invention is achieved in that a location of the particular triangle vertex is inside the cell. Compared to the marching cubes method, the main differences are that the triangle vertices are inside the cell instead of on its edges, and that the triangles connect interior points of neighboring cells instead of edge points of the same cell. The discretization of the implicit surface through the triangle vertices are displaced from each other by half a grid cell. The method according to the invention solves in a simple and elegant manner the “crack” problem discussed above. The absence of cracks is guaranteed, since there are no triangle vertices or edges on the cell face. An other advantage of the method according to invention is that the computational effort is smaller than that of the marching cube method, because no effort has to be spent on handling the “crack” problem.

Although specified for the 3-Dimensional case, this method can also be used in cases with another number of dimensions, e.g. in the 2-Dimensional case.

In an embodiment of the method according to the invention the location of the particular triangle vertex is substantially equal to a center of the cell. This is a relatively simple approach to determine the triangle vertices with relatively low computational effort.

In an embodiment of the method according to the invention the location of the particular triangle vertex is calculated based on values assigned to the cell vertices. The calculation of the location of the particular triangle vertex can be performed by means of e.g.:

linear interpolation of values of u assigned to the cell vertices of the cell. Linear interpolation is a relatively simple approach to determine the triangle vertices with relatively low computational effort resulting in triangles that are not aligned with the cell grid.

weighted interpolation of values of u assigned to the cell vertices of the cell. By means of weighted interpolation it is possible to deal with uncertainty in the values assigned to the cell vertices. These values correspond to measurement samples of values of a predetermined property. Because of measurement errors the measured samples might differ from the actual values.

In the case of interpolation the location of the particular triangle vertex can be anywhere inside the cell. The result is that the triangle vertices will not be aligned with the coordinate directions, i.e. there is no inherent alignment with any of the coordinate planes. This is a major advantage of the method. In general a triangulated implicit surface is not C¹-continuous at the triangle edges. This doesn't have to result in visual artifacts. However in the marching cubes method it does. All triangle vertices are on the cell edges. As a result, many triangle edges are aligned with the cell grid, and therefore annoying visual artifacts result. In particular, this is visible with animated iso-surfaces. To remedy this, the cell resolution should be set to much finer values as required by the intrinsic shape properties of the iso-surface, e.g. the curvature radii. It can be argued that, since the implicit surface is not dependent on the choice of the cell grid, neither should be its discretized approximation, i.e. triangulated surface. The discretization can then be much coarser as in marching cubes without introducing artifacts, thus reducing the number of required triangles considerably.

In an embodiment of the method according to the invention the location of the particular triangle vertex is calculated based on values assigned to cell vertices of multiple cells. The calculation of the location of the particular triangle vertex can be performed by means of e.g. linear interpolation or weighted interpolation of values assigned to the cell vertices of the cells. This enables the minimization of an error norm of the implicit surface: By taking into account values assigned to cell vertices of multiple cells, the approximation of the implicit surface, i.e. the triangulated surface, can be smoothed. Since the choice of the triangle vertices is to a large extent free, here is an additional option for obtaining a maximally smooth mesh without the expense of having more triangles. The marching cubes method lacks this freedom.

In an embodiment of the method according to the invention a first triangle vertex located in a first cell is connected to a second triangle vertex located in a second cell if the first cell and the second cell share an edge that crosses the implicit surface. The triangulated surface is created by connecting the triangle vertices of relevant neighboring cells. These relevant neighboring cells are searched on an edge-base:

Each cell edge which crosses the implicit surface, which is called a zero edge, is visited in turn. These cell edges can easily be found, since the two cell vertices forming the end points of this cell edge have opposite signs of the function f(u).

For every zero edge the relevant neighboring cells are searched. These are the cells that share the zero edge: Cells which comprise the zero edge or a portion of the zero edge, and for which this zero edge or a portion of the zero edge also crosses the implicit surface.

After having found the relevant neighboring cells the triangles can be created by connecting the appropriate triangle vertices. The triangulation is cell edge based. In the marching cubes method the triangulation is cell-based.

In an embodiment of the method according to the invention the method comprises:

a count step to determine whether there is a third cell that shares the edges that crosses the implicit surface; and

a connect step to connect the first triangle vertex to the second triangle vertex if the third cell does not exist.

If cells differ in size then a cell can have multiple neighboring cells on the same side. Suppose that the first cell is bigger than the second cell then the first cell will share one of its edges with both the second cell and a third cell. It is not always obvious to determine in which of the two neighboring cells, i.e. the second or the third, a triangle vertex can be found to be connected to the triangle vertex of the first cell. However for the smaller cells it is unambiguous. Therefore the creation of the connection between triangle vertices is initiated from the triangle vertex located in the smallest cell of two neighbors. This strategy reduces the computational effort.

The second object of the invention is achieved in that the surface generator unit is designed to determine a location of a particular triangle vertex which is inside the cell.

The third object of the invention is achieved in that the image display apparatus comprises a surface generator unit being designed to determine a location of a particular triangle vertex which is inside the cell.

These and other aspects of the surface generator unit for and method of approximating an implicit surface and the image display apparatus according to the invention will become apparent from and will be elucidated with reference with respect to the implementations and embodiments described hereinafter and with reference to the accompanying drawings, wherein:

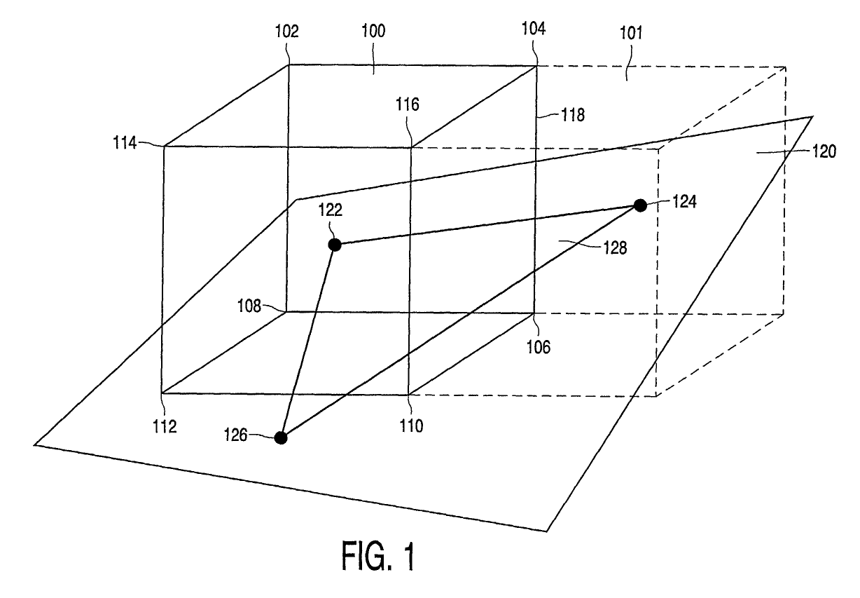

FIG. 1 schematically shows a portion of an implicit surface which is implicitly defined by the values assigned to cell vertices;

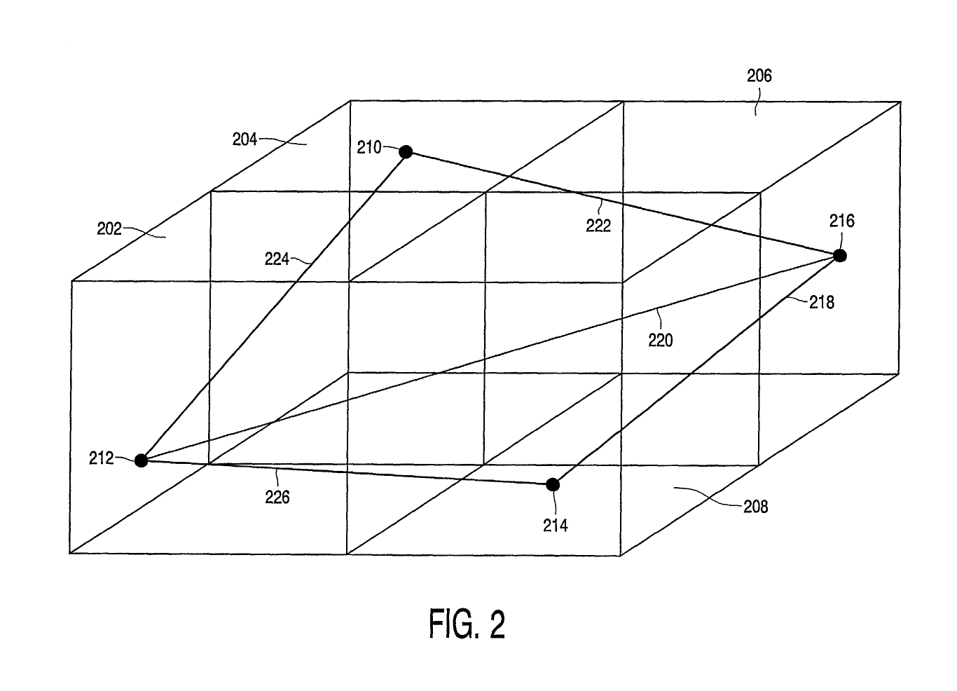

FIG. 2 schematically shows a portion of a triangulated surface;

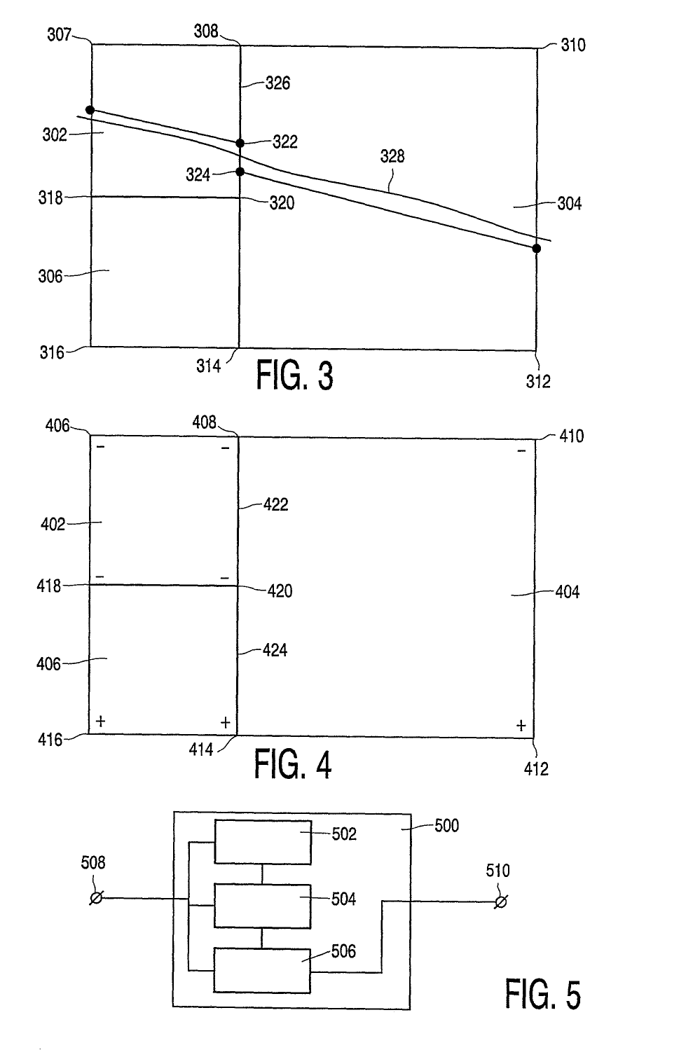

FIG. 3 illustrates the “crack” problem;

FIG. 4 illustrates that a cell can have multiple neighboring cells sharing one edge;

FIG. 5 schematically shows a surface generator unit;

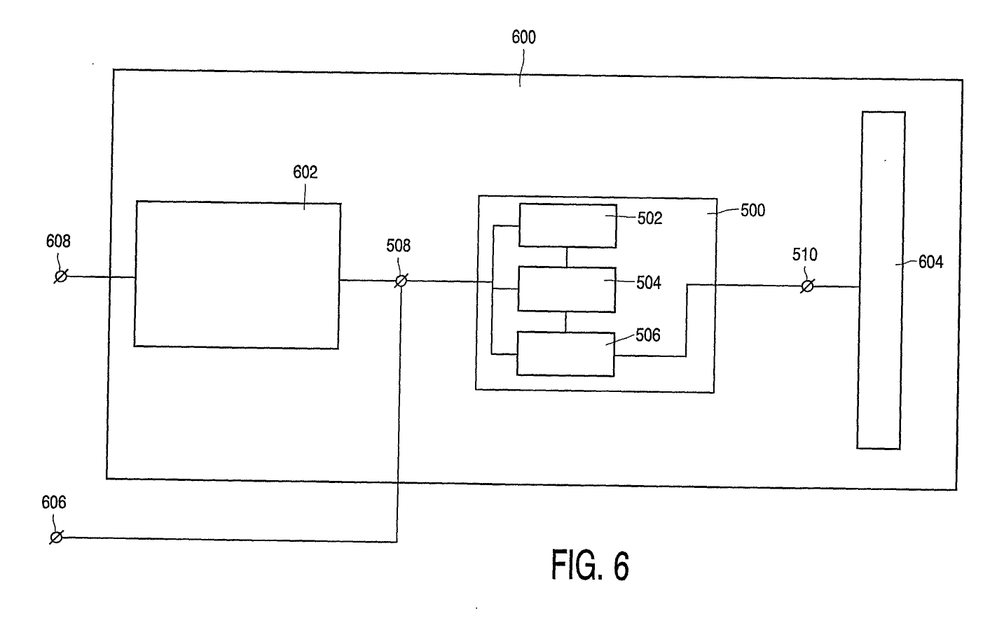

FIG. 6 schematically shows an image display apparatus; and

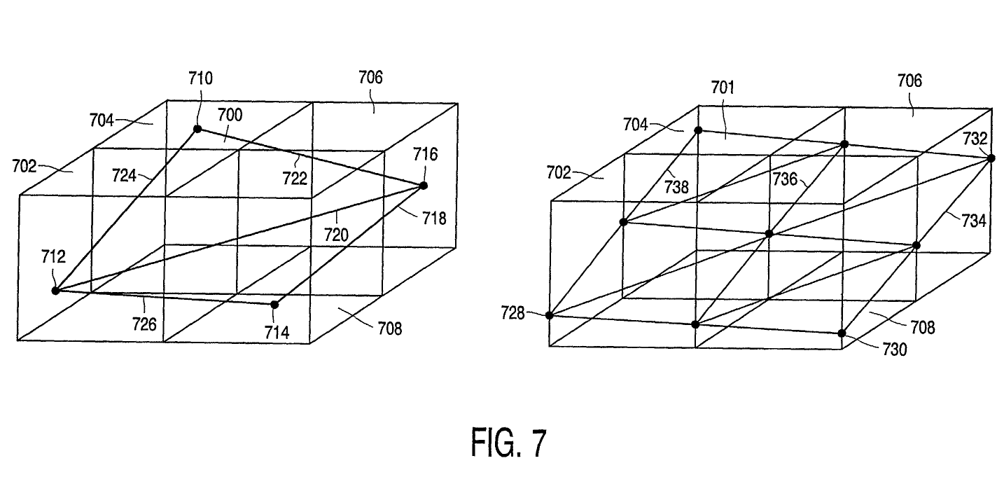

FIG. 7 schematically shows portions of two triangulated surfaces.

FIG. 1 schematically shows a portion of an implicit surface 120 which is implicitly defined by the values assigned to the cell vertices 102-116 of the cell 100. A triangle vertex 122 which is located inside the cell 100, is calculated based on the values assigned to the cell vertices 102-116. Other triangle vertices 124-126 are calculated for neighboring cells, e.g. 101. The triangle 128 is defined by its triangle vertices 122-126. The cell 100 has 12 edges, of which some, e.g. edge 118, cross the implicit surface 120. An edge that crosses the implicit surface can be used to determine relevant neighboring cells, e.g. cell 101.

FIG. 2 schematically shows a portion of a triangulated surface, i.e. two triangles. These triangles are defined by the triangle vertices 210-216. A triangle vertex 210216 is calculated in each of the four cells 202-208: 212 inside 202, 210 inside 204, 216 inside 206 and 214 inside 208. These triangle vertices are connected by means of triangle edges 218-224.

FIG. 3 illustrates the “crack” problem known from the marching cubes method. FIG. 3 schematically shows 3 cells 302-306. The implicit surface 328 is defined by the cell vertices 307-320. This implicit surface is C⁰-continuous. However with the marching cubes method a C⁰-discontinuity will appear at the cell edge 326. The location of triangle vertex 322 which is situated at the cell edge 326 and which belongs to a triangle located in cell 302 is not mutual equal with the location of triangle vertex 324 which is also situated at the cell edge 326 but which belongs to a triangle located in cell 304. The result is that the triangulated surface has a C⁰-discontinuity at the cell edge 326: triangles of neighboring cells 302-304 are not connected.

FIG. 4 illustrates that a cell 404 can have multiple neighboring cells 402 and 406 sharing a cell edge 422 respectively 424. For each of the cell vertices the sign, i.e. “−” or “+” of the values of a predetermined property u is indicated:

u<0 for cell vertices 406, 408, 410, 418 and 420

u>0 for cell vertices 412, 414 and 416.

Although cell 404 has two neighboring cells 402 and 406, there is only one relevant neighboring cell. The cell edge of cell 404, which forms the connection between the cell vertices 408 and 414 is an edge that crosses the implicit surface, because 408 and 414 have different sign. Cell 402 can not be a relevant neighboring cell because the cell edge 422 does not cross the implicit surface. Cell 406 is the relevant neighboring cell because the cell edge 424 crosses the implicit surface.

FIG. 5 schematically shows a surface generator unit 500 which comprises:

a triangle vertex calculator 502 designed to calculate the location of a triangle vertex;

an edge searcher 504 designed to search zero edges and for relevant neighboring cells; and

a connector 506 designed to connect triangle vertices in order to create triangles.

The surface generator unit 500 requires its input at the input connector 508 and provides its output at the output connector 510. The input is a multi-dimensional data structure holding an implicit surface, i.e. a cell-based structure with values assigned to the vertices of the cells. The output is a triangulated surface. The surface generator unit 500 performs the following operations:

The edge searcher 504 processes the cells searching for zero edges, being edges that cross the implicit surface. These cell edges can easily be found, since the two cell vertices forming the end points of this cell edge have opposite signs of the function f(u).

For every zero edge the relevant neighboring cells is searched by the edge searcher 504. These are the cells that share the zero edge, i.e. cells which also comprise the zero edge or a portion of the zero edge, and for which this zero edge or a portion of the zero edge also crosses the implicit surface.

In each of the relevant neighboring cells, one point is chosen or calculated which serves as a triangle vertex. This triangle vertex can be obtained in many ways: e.g., the cell center or obtained through some interpolation of the values of u assigned to the cell vertices or the cell vertices of multiple cells in order to minimize an adequate error norm. The triangle vertex calculator 502 might comprise one or more interpolators, each designed to perform an appropriate interpolation of values assigned to vertices of one or multiple cells.

Finally the connector 506 connects the triangle vertices of relevant neighboring cells in order to create triangles.

FIG. 6 schematically shows an embodiment of an image display apparatus 600 which is able to create a data volume out of a set of two dimensional images, to generate triangulated surfaces and to visualize these surfaces. Visualization of data volumes is of crucial importance in many areas, such as:

Visualization of 3-Dimensional models in the computer graphics, video and 3-Dimensional TV domain.

Volume visualization in medical imaging, e.g. virtual endoscopy.

Generation of reconstructed objects in industrial inspection, e.g. for quality control purposes.

General scientific visualization of measured or simulated physical quantities in several engineering branches such as computational fluid dynamics or geophysics.

The image display apparatus 600 comprises:

a reconstructor 602 which is able to create a data volume, i.e. to reconstruct three dimensional data structures, out of a set of two dimensional images. This reconstructor is optionally. It is also possible to provide three dimensional data structures to the input connector 606.

a surface generator unit 500 as described in FIG. 5; and

a display device 604.

The input of the reconstructor 602 is a sequence of images provided at the input connector 608. These images are processed in a number of steps. First depth-maps are generated for these images, e.g. by making use of parallax. The depth-maps are input for the reconstructor 602 which is designed to generate a 3-Dimensional cell-based structure implicitly defining the surfaces of objects in the imaged scene. The incoming images represent these objects. The output of the reconstructor 602, being a 3-Dimensional cell-based structure holding the implicit surfaces of the objects is input for the surface generator unit 500. The surface generator unit 500 is able to create triangulated surfaces and to render these triangulated surfaces into 2-Dimensional images. These rendered images may correspond to views which have not originally been made by the camera capturing the scene. The rendered 2-Dimensional images are displayed by the display device 604. The display device 604 might be a regular display device but it might also be a type that is able to display pairs or groups of images representing views from slightly different angles: a stereoscopic display device respectively a “multiscopic” display device with e.g. a lenticular screen. For performance reasons the reconstructor 602 and the surface generator unit 500 might be implemented on silicon, i.e. dedicated hardware. In case of less performance critical circumstances a programmable hardware platform might be sufficient to realize these units.

FIG. 7 schematically shows portions of two triangulated surfaces 700 and 701. Surface 700 is generated with the method according to the invention. Surface 701 is generated with the marching cubes method. In both cases those triangles are shown which are defined by triangle vertices which have been calculated based on values assigned to the vertices of the cells 702-708. In the triangulated surface 700 these triangle vertices 710-714 are connected with triangle edges 718-724. For the triangulated surface 701 these triangle vertices are referenced with e.g. 728-732. The main difference between the group of triangle vertices of the triangulated surface 700 and of the group of triangle vertices of the triangulated surface 701 is that in the latter group the triangle vertices are located at the edges of the cells 702-708 and that in the former group the triangle vertices are located inside the cells 702-708. The number of triangles generated with the marching cubes method is higher than the number of triangles created with the method according to the invention. The triangle vertices, e.g. 734-738, of the triangulated surface 701 are mutually aligned. Most of these triangle vertices are located in a face of cell 702-708. A result of this alignment can be visual artifacts.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A method of approximating an implicit surface (120) by generation of a triangulated surface comprising a plurality of triangles (128) each having triangle vertices (122-126), whereby a particular triangle vertex (122) is based on values assigned to cell vertices (102-116) of a cell (100) corresponding with the particular triangle vertex (122), characterized in that a location of the particular triangle vertex (122) is inside the cell (100).

2. A method as claimed in claim 1, characterized in that the location of the particular triangle vertex (122) is substantially equal to a center of the cell (100).

3. A method as claimed in claim 1, characterized in that the location of the particular triangle vertex (122) is calculated based on values assigned to the cell vertices (102-116).

4. A method as claimed in claim 3, characterized in that the location of the particular triangle vertex (122) is calculated by means of linear interpolation of values assigned to the cell vertices (102-116).

5. A method as claimed in claim 3, characterized in that the location of the particular triangle vertex (122) is calculated by means of weighted interpolation of values assigned to the cell vertices (102-116).

6. A method as claimed in claim 1, characterized in that the location of the particular triangle vertex (122) is calculated based on values assigned to cell vertices of multiple cells (100,101).

7. A method as claimed in claim 6, characterized in that the location of the particular triangle vertex (122) is calculated by means of linear interpolation of values assigned to the cell vertices of multiple cells (100,101).

8. A method as claimed in claim 6, characterized in that the location of the particular triangle vertex (122) is calculated by means of weighted interpolation of values assigned to the cell vertices of multiple cells (100,101).

9. A method as claimed in claim 1, characterized in that a first triangle vertex (122) located in a first cell (100) is connected to a second triangle vertex (124) located in a second cell (101) if the first cell (100) and the second cell (101) share an edge (118) that crosses the implicit surface (120).

10. A method as claimed in claim 9, characterized in that the method comprises
a count step to determine whether there is a third cell that shares the edges (118) that crosses the implicit surface (120); and
a connect step to connect the first triangle vertex (122) to the second triangle vertex (124) if the third cell does not exist.

11. A surface generator unit (500) for approximating an implicit surface (120) by generation of a triangulated surface comprising a plurality of triangles (128) each having triangle vertices (122-126), whereby a particular triangle vertex (122) is based on values assigned to cell vertices (102-116) of a cell (100) corresponding with the particular triangle vertex (122), characterized in that the surface generator unit (500) is designed to determine a location of the particular triangle vertex (122) which is inside the cell (100).

12. A surface generator unit (500) as claimed in claim 11, characterized in that the surface generator unit (500) is designed to calculate the location of the particular triangle vertex (122), based on values assigned to the cell vertices (102-116).

13. A surface generator unit (500) as claimed in claim 12, characterized in that the surface generator unit (500) is designed to calculate the location of the particular triangle vertex (122) by means of linear interpolation of values assigned to the cell vertices (102-116).

14. A surface generator unit (500) as claimed in claim 12, characterized in that the surface generator unit (500) is designed to calculate the location of the particular triangle vertex (122) by means of weighted interpolation of values assigned to the cell vertices (102-116).

15. A surface generator unit (500) as claimed in claim 11, characterized in that the surface generator unit (500) is designed to calculate the location of the particular triangle vertex (122), based on values assigned to cell vertices of multiple cells (100,101).

16. A surface generator unit (500) as claimed in claim 15, characterized in that the surface generator unit (500) is designed to calculate the location of the particular triangle vertex (122) by means of linear interpolation of values assigned to the cell vertices of multiple cells (100,101).

17. A surface generator unit (500) as claimed in claim 15, characterized in that the surface generator unit (500) is designed to calculate the location of the particular triangle vertex (122) by means of weighted interpolation of values assigned to the cell vertices (102-116) of multiple cells (100,101).

18. A surface generator unit (500) as claimed in claim 11, characterized in that the surface generator unit (500) is designed to connect a first triangle vertex (122) located in a first cell (100) to a second triangle vertex (124) located in a second cell (101) if the first cell (100) and the second cell (101) share an edge (118) that crosses the implicit surface (120).

19. A surface generator unit (500) as claimed in claim 18, characterized in that the surface generator unit (500) is designed:
to determine whether there is a third cell that shares the edges (118) that crosses the implicit surface (120); and
to connect the first triangle vertex (122) to the second triangle vertex (124) if the third cell does not exist.

20. An image display apparatus (600) comprising:
a reconstructor (602) designed to generate a cell-based structure to hold an implicit surface (120);
a surface generator unit (500) for approximating the implicit surface (120) by generation of a triangulated surface comprising a plurality of triangles (128) each having triangle vertices (122-126), based on values assigned to cell vertices (102-116) of a cell (100); and
a display device (604) to display the triangulated surface, characterized in that the surface generator unit (500) is designed to determine a location of a particular triangle vertex (122) which is inside the cell (100).
